(19) United States
(12) Patent Application Publication
(10) Pub. No.: US 2006/0275583 A1
(43) Pub. Date: Dec. 7, 2006

(54) Printing material, method of manufacturing the printing material and stamp having the printing material

(75) Inventors: Hiromi Kitamura, Nagoya-shi (JP); Kazuyuki Kanbe, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/442,167

(22) Filed: May 30, 2006

(30) Foreign Application Priority Data
Jun. 7, 2005 (JP) 2005-166344
Dec. 22, 2005 (JP) 2005-369223

(51) Int. Cl. B32B 3/00; B05D 3/02; B05D 1/18; B41K 1/42

(52) U.S. Cl. 428/156; 427/430.1; 427/372.2; 101/333

(57) ABSTRACT

A printing surface, protruded portion, and joining portion are obtained by forming polyolefin resin integrally. Next, a formed overall printing material is dipped in ink for several hours. After an ink saturating portion is saturated with ink sufficiently, the printing material is entirely placed in an incubator at 50 to 75° C. and heated for 1 to 12 hours. As a consequence, the entire surface of the printing material is shrunken by about 0.5 to 5% so as to obtain a surface portion.

### CROSS-REFERENCE TO RELATED APPLICATIONS

This application claims priority from JP 2005-166344, filed Jun. 7, 2005, and JP 2005-369223, filed Dec. 22, 2005, the contents of which are incorporated in their entireties herein by reference thereto.

### BACKGROUND

The disclosure relates to a printing material, a manufacturing method of the printing material, and a stamp having the printing material.

Generally, a stamp is capable of printing several times continuously. The stamp being produced by forming its printing material having an uneven printing surface containing porous material (hereafter referred as “print body”) and saturating it with ink. Such a printing material is compressed and deformed by applying a pressure at the time of stamping so that ink is squeezed out to the surface so as to form a print image.

However, the print image may be blurred due to a shortage of pressure or ink may be squeezed excessively due to an exceeding pressure so that the image is spread out because of the pressure applied to the printing material, which is not always appropriate.

To prevent fluctuation of the printing quality and to obtain a print image, for example, Japanese Patent Application Laid-Open No. SH060-143990 and Japanese Patent Application Laid-Open No. SH060-220781 disclose a method of manufacturing a print body by overlaying an intermediate rubber layer and a porous rubber coating layer. Each layer has a different hardness on a primarily formed rubber base layer so as to obtain a sharp print image.

### SUMMARY

However, the print body produced by the conventional manufacturing method is formed through two stages for preparing rubber materials with different hardness.

To address the above-described problems and other problems, there is provided a printing material, which is manufactured from a single material to obtain a sharp print image, a method of manufacturing the printing material, and a stamp having the same printing material.

Additionally, there is provided a printing material formed of thermoplastic porous resin, comprising a saturating portion that is saturated or saturated with ink; and a surface portion formed by hardening with shrinkage when the surface of the saturating portion saturated with the ink is heated.

Moreover, there is provided a method of manufacturing the printing material comprising forming step of forming a printing portion using thermoplastic resin having pores; ink saturating step of saturating the pores with ink by dipping the printing portion in ink after it is formed in the forming step; and heating step of hardening the surface of the saturating portion saturated with ink with shrinkage.

Further, there is provided a stamp with a printing material formed of thermoplastic porous resin, comprising an saturating portion that is saturated with ink; and a surface portion formed by hardening with shrinkage when the surface of the saturating portion saturated with the ink is heated.

### BRIEF DESCRIPTION OF THE DRAWINGS

Exemplary embodiments of the invention will be described in detail with reference to the accompanying drawings in which:

FIG. 1 is a plan view of a printing material;

FIG. 2 is a sectional view of a protruded portion of the printing material;

FIG. 3 is a sectional view of the protruded portion of the printing material after being saturated with ink;

FIG. 4 is a sectional view of the protruded portion of the printing material after being heated;

FIG. 5 is a sectional view of the protruded portion of the printing material after being heated;

FIG. 6 is a sectional view of a date stamp;

FIG. 7 is a graph showing the relation between annealing temperature and shrinkage rate for printing material A; and

FIG. 8 is a graph showing the relation between the annealing temperature and shrinkage rate for printing material B.

### DETAILED DESCRIPTION OF EMBODIMENTS

Hereinafter, a printing material for a date stamp 1, which enables a printing surface of the printing material to be changed by rotation, will be described with reference to the drawings.

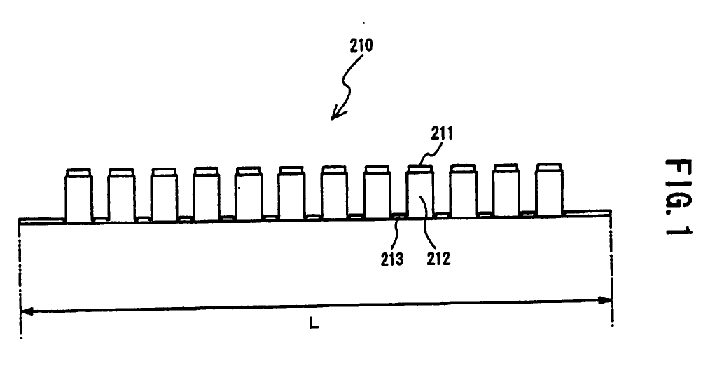

As shown in FIG. 1, a printing material 210 is formed of polyolefin porous resin by joining a plurality of substantially rectangular protruded portions 212 with a plurality of joining portions 213. The protruded portion 212 having a printing face 211 disposed at approximately each front end portion of the protruded portion 212. The printing face 211 is uneven to form a print image, for example, a number, character, symbol, or the like. That is, the number, character, symbol, or the like, is formed unevenly on the printing face 211. Accordingly, the printing material 210 is used as a printing portion of a changeable date stamp. For example, a number of 0 to 9 or a number of 1 to 12 is formed on the printing face 211 and the printing material 210 has protruded portions 212 of the quantity that needs to be changed. Thus, more than one printing face 211 may be used so that any combination of numbers, characters, and symbols may be stamped, for example.

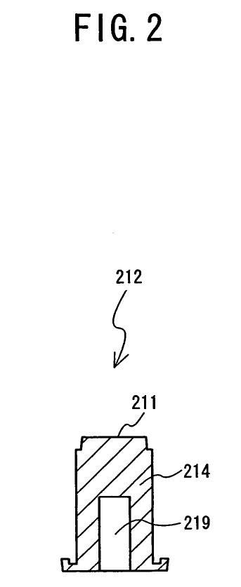

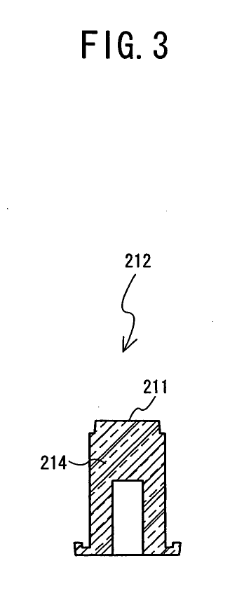

The protruded portion 212 of the printing material 210 having the above-described structure is formed of polyolefin porous resin having a cavity 219, as shown in FIG. 2. A portion other than the cavity 219 in the protruded portion 212 defines an ink saturating portion 214, which holds ink in its pores to supply ink to the printing face 211. When the printing material 210 is entirely saturated with ink, ink enters the pores in the protruded portion 212 so that the ink saturating portion 214 holding ink is produced, as shown in FIG. 3.

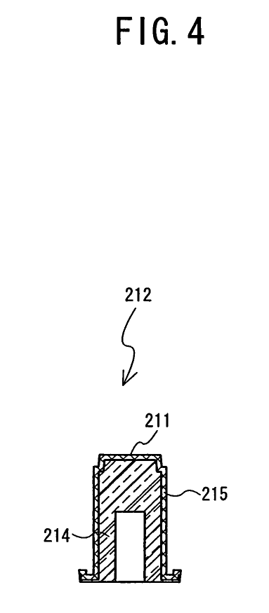

Because the polyolefin resin that forms the printing material 210 is a thermoplastic resin, the surface thereof is shrunken and hardened by heat. As shown in FIG. 4, the entire surface is heated by annealing in an incubator, so that a surface portion 215 having a higher density than internally is obtained.

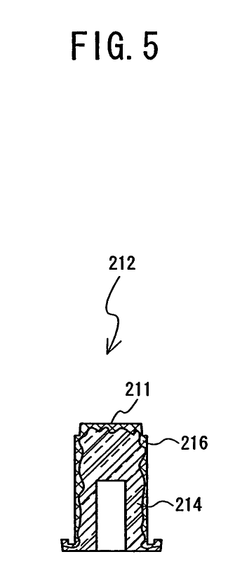

Also, the surface portion is not restricted to a layered structure relative to the ink saturating portion 214, as shown in FIG. 4, but may be a surface portion 216 whose shrunken portion is uneven, as shown in FIG. 5.

To manufacture such a printing material 210, first, a polyolefin resin is formed integrally to obtain a printing surface 211 that is uneven, a protruded portion 212, and a joining portion 213. Next, the overall printing material 210 comprised of the printing surface 211 after it is formed, the protruded portion 212, and the joining portion 213, is dipped in ink for several hours. After it is sufficiently saturated with ink, the overall printing material 210 comprised of the printing surface 211, the protruded portion 212, and the joining portion 213, is heated in the incubator at 55 to 75° C. for more than an hour. Then, the entire surface of the printing material 210 is shrunken by about 0.5 to 5% so as to obtain the surface portion 215. Because the printing surface 211 forms part of the surface portion 215, the uneven portion of the printing surface 211 that forms a print image is shrunken and hardened so that the hardness of the surface portion 215 is intensified. Accordingly, the print image is not blurred or spread out by the unevenness of the printing surface 211 when pressure is applied. Thus, a sharp image can be obtained. As a result of hardening with shrinkage, the diameter of a pore in the surface portion 215 becomes smaller than the diameter of a pore inside the printing material 210, so that the surface portion 215 is supplied with ink from the inside of the printing material 210 by capillary forces; thus, reducing or blocking the blurring of the print image. Further, because the ink follow-up performance is excellent, the density of the print image is maintained during continuous or repetitive stamping.

If the shrinkage rate is less than 0.5%, the blurring or spreading-out of the print image may occur. If the shrinkage rate exceeds 5%, the print image may shrink too much, such that the print image may become a different image from its intended print image or its heat resistance may deteriorate. Further, because the annealing condition to obtain a desirable shrinkage rate differs depending on the character of the printing material, a shrinkage rate of 0.5 to 5% is used to obtain stability.

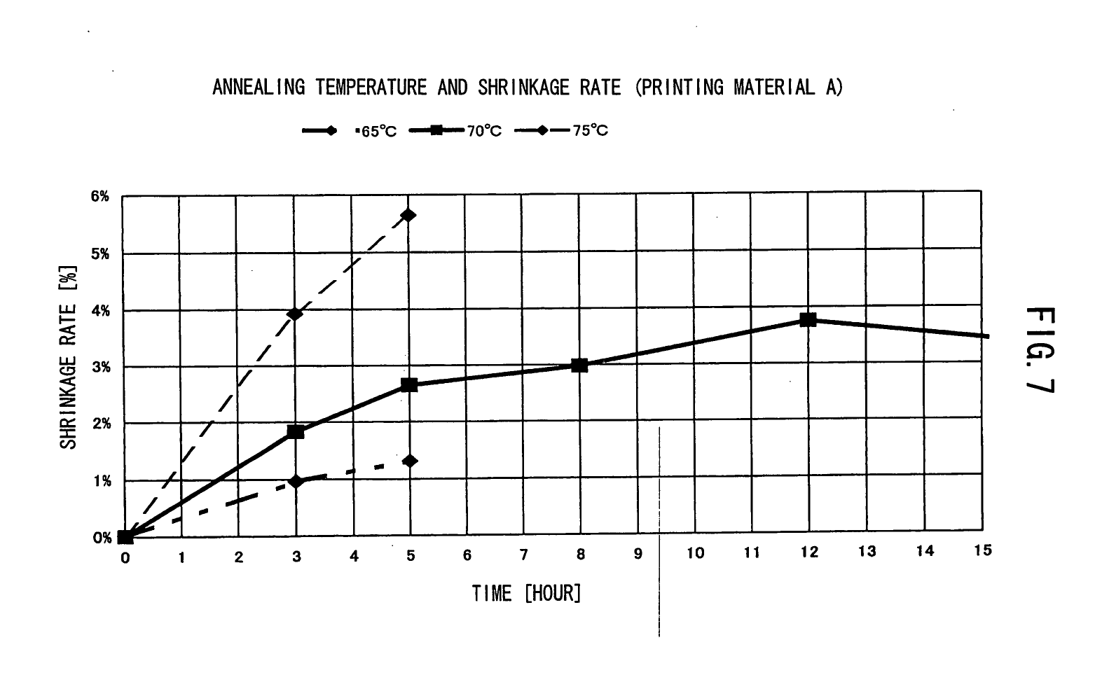

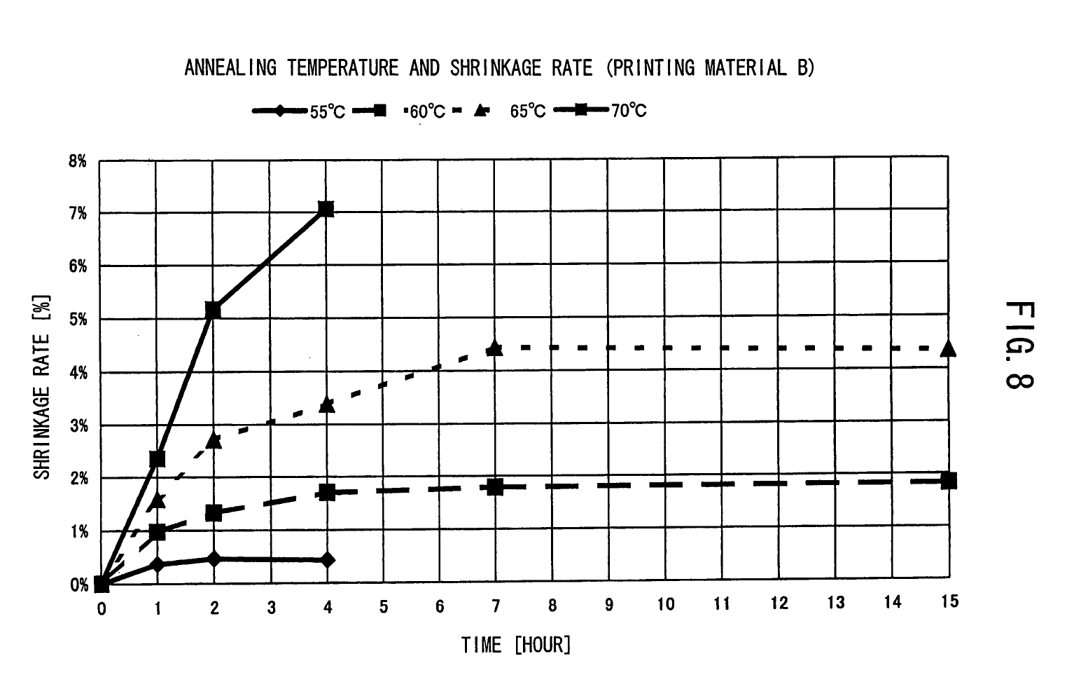

Next, example 1 and example 2 will be described with reference to FIGS. 7 and 8. In example 1 and example 2, the shrinkage rate was measured by changing the annealing condition of printing material A and printing material B. The printing material A is a different material than that of the printing material B.

### EXAMPLE 1

The printing material A composed of a polyolefin resin was heated in an incubator at 65° C., 70° C., and 75° C. and the shrinkage rates were measured. For measurement of the shrinkage rate, a length L in a length direction of the printing material 210 formed in a rectangular shape (see FIG. 1) is measured before and after heating and a difference AL between the both lengths is divided by the length L. The measurement of the shrinkage rate may also be based on the width of the printing material 210 or the height of the protruded portion 212 as well as the length of the printing material 210. In this embodiment, the measurement of the shrinkage rate was executed using the length L of the printing material 210. As shown in FIG. 7, when the printing material A was heated at 65° C., the surface portion 215 having a shrinkage rate of about 1.0% was obtained after three hours and the surface portion 215 having a shrinkage rate of about 1.3% was obtained after five hours. When the printing material A was heated at 70° C., the shrinkage rate of the obtained surface portion 215 is about 1.8% after three hours, about 2.7% after five hours, about 3% after eighth hours, and about 3.7% after 12 hours. Further, when the printing material A was heated at 75° C., the shrinkage rate of the obtained surface portion 215 is about 3.9% after three hours and about 5.6% after five hours.

### EXAMPLE 2

A printing material B, composed of polyolefin resin was heated in an incubator at 55° C., 60° C., 65° C., and 70° C. and the shrinkage rates were obtained by measuring the length L in the same way as example 1. The printing material B is formed of material having a different character from the printing material A. As shown in FIG. 8, when the printing material B was heated at 55° C., the shrinkage rate of the obtained surface portion 215 is about 0.4% after one hour, about 0.5% after two hours, and about 0.4% after four hours. Further, when the printing material B was heated at 60° C., the shrinkage rate of the obtained surface portion 215 is about 1.0% after one hour, about 1.3% after two hours, about 1.7% after four hours, about 1.8% after seven hours, and about 1.8% after 15 hours. Further, when the printing material B was heated at 65° C., the shrinkage rate of the obtained surface portion 215 is about 1.6% after one hour, about 2.7% after two hours, about 3.4% after four hours, about 4.4% after seven hours, and about 4.4% after 15 hours. When the printing material B was heated at 70° C., the shrinkage rate of the obtained surface portion 215 is about 2.4% after one hour, about 5.2% after two hours, and about 7.0% after four hours.

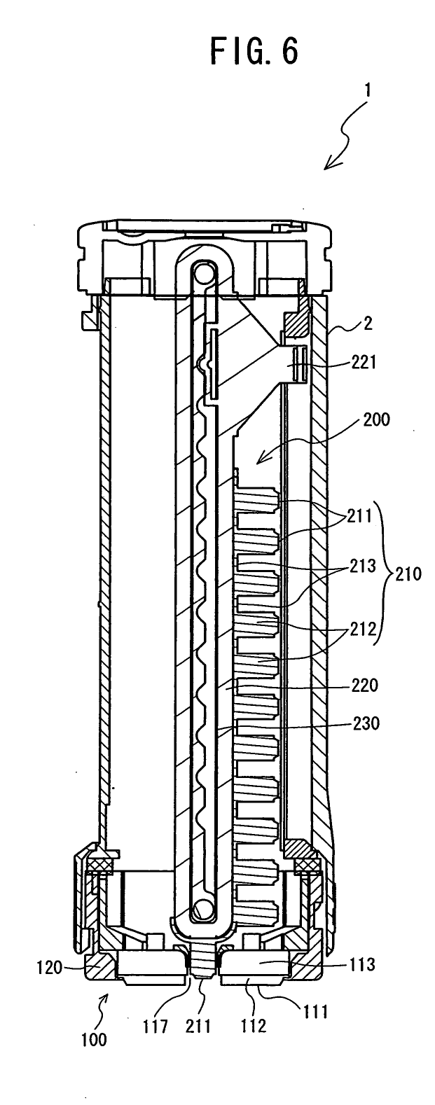

Next, a date stamp 1, which is a stamp that uses the above-described printing material 210, will be described. As shown in FIG. 6, the date stamp 1 has a substantially circular printing surface, which is perpendicular to the axial direction of a main body case 2 at an end portion of the substantially cylindrical main body case 2. This printing surface forms a print image by synthesizing a printing surface whose print image is unchanged with a print surface, which allows a print image of any date to be formed by combining numbers or symbols. The print surface is formed from the printing material 210.

The main body case 2 includes a rotatable printing portion 200, which holds the printing material 210, and a fixed print portion 100, which holds a printing surface 111 whose print image is unchanged. The fixed printing portion 100 includes a fixed print body 112 having the printing surface 111 and an ink storage body 113 which makes contact with the fixed print body 112 so as to supply ink. The fixed print body 112 and the ink storage body 113 are held by a holding member 120, which is fitted to the internal periphery of the main body case 2.

The ink storage body 113 is held by the holding member 120 on the back face of the fixed print body 112 having the printing surface 111 in the fixed printing portion 100. The ink storage body 113 is formed of a porous resin, for example, which can store ink by being saturated with ink. The fixed print body 112 is formed of a porous resin similar to the ink storage body 113. The printing surface 111 is formed by exposing a portion, which is to be turned into a print image of the fixed print body 112, to light in a condition in which the portion of printing surface 111 is masked while being compressed and then fusing the exposed portion so as to fill the pores as well known. A substantially rectangular hole portion 117 is formed substantially in the center of the fixed print body 112 and the printing surface 211 of the rotatable printing portion 200 is exposed through the hole portion 117.

The rotatable printing portion 200 is so constructed that five printing materials 210 are held by the substantially rectangular holding body 230 in the main body case 2. The holding body 230 is provided in parallel with five belt bodies 220, which are rotatable individually along the length direction. The printing material 210 is provided on an outer peripheral face of each belt body 220. The printing material 210 provided on each belt body 220 has a length less than half the circumference of the belt bodies 220 and is fixed so that the printing material 210 position is moved with a rotation of each belt body 220. A slide portion 221 for sliding each belt body 220 to rotate each belt bodies 220 individually is provided protrudedly on the outer peripheral face of each belt bodies 220. Each belt body 220 is rotated by sliding the slide portion 221 along the length direction of the main body case 2.

According to the date stamp 1 having the above-described structure, when a handler applies a pressure in the axial direction of the main body case 2 with its printing surface in contact with a print object medium, ink is supplied from the ink storage body 113 to the printing surface 111 and ink is supplied to the printing surface 211 from the ink saturating portion 214 of the printing material 210 so that a synthesized print image is formed on the print object medium. Because the printing surface 211 has a hardness higher than the ink saturating portion 214 due to the formation of the surface portion 215 by heating, the print image is not blurred or spread out due to deformation by pressure applied to the printing surface 211 by a pressing force. Thus, a sharp print image can be obtained.

As described above, the thermoplastic porous resin is formed and heated after its pore portion is saturated with ink. As a consequence, the surface is hardened with shrinkage so as to increase the hardness of the surface portion. Thus, a stamp using this printing material causes no blurring or spreading out of a print image due to excessive deformation by pressure. Accordingly, a sharp print image is obtained.

Because the thermoplastic resin used for the printing material is a polyolefin resin, a printing material capable of providing a sharp print image can be obtained easily at a low cost by forming the material used for the printing material before and subsequently, heating it after being saturated with ink.

According to the manufacturing method of the printing material, the printing surface is formed using thermoplastic resin and after saturating the printing portion with ink, it is heated so as to harden the surface of the saturating portion with shrinkage. Because the printing portion is only heated after being formed, a desired printing material can be obtained without using additional complicated steps.

Further, because the method of manufacturing the printing material uses polyolefin resin, the difficulties that may occur in forming the printing material due to changes of a material during manufacturing is avoided.

The stamp includes the printing material, which is formed of thermoplastic porous resin and whose surface is hardened with shrinkage so that the hardness of the surface is increased by heating the same surface after its pore portion is saturated with ink. As a consequence, the print image is not blurred or spread out due to excessive deformation by pressure when it is stamped. Thus, a sharp print image can be obtained.

Because the thermoplastic resin used for the printing material comprises a polyolefin resin, a sharp print image can be obtained easily and at a low cost by forming the printing material and heating it after being saturated with ink.

Although the invention has been described with reference to exemplary embodiments, it is to be understood that the invention is not limited to the exemplary embodiments or structures. Though various elements of the exemplary embodiments are shown in various combinations and configurations, which are exemplary, other combinations and configurations, including more, less or only a single element, are also within the spirit and scope of the invention.

What is claimed is:

1. A printing material formed of a thermoplastic porous resin, comprising:
a saturating portion being saturated with ink; and
a surface portion formed by hardening with shrinkage when the surface of the saturating portion saturated with the ink is heated.

2. The printing material according to claim 1, wherein the thermoplastic resin is a polyolefin resin.

3. The printing material according to claim 1, wherein the surface portion has a higher density than the saturating portion of the printing material.

4. The printing material according to claim 1, wherein the surface portion has a hardness higher than the ink saturating portion.

5. The printing material according to claim 1, further comprising:
a plurality of protruded portions; and
a plurality of joining portions joined to the plurality of protruded portions.

6. The printing material according to claim 5, wherein the plurality of protruded portions are substantially rectangular.

7. The printing material according to claim 5, wherein each one of the protruded portions includes a printing face disposed at approximately each one of a front end portion of the protruded portions.

8. The printing material according to claim 7, wherein the printing face is uneven to form a print image.

9. The printing material according to claim 8, wherein the printing face comprises at least one of a number, character, and symbol.

10. The printing material according to claim 1, further comprising a protruded portion having a cavity.

11. A changeable date stamp comprising the printing material according to claim 1.

12. A method of manufacturing a printing material, comprising:
forming step of forming a printing portion using thermoplastic resin having pores;
ink saturating step of saturating the pores with ink by dipping the printing portion in ink after the printing portion is formed in the forming step; and
heating step of hardening a surface of the saturating portion of the printing material saturated with ink with shrinkage by heating the printing portion after saturating with ink through the ink saturating step.

13. The manufacturing method according to claim 12, wherein the thermoplastic resin is a polyolefin resin.

14. The manufacturing method according to claim 12, wherein the heating step includes annealing the printing material so that the surface portion has a higher density than the ink saturating portion.

15. The method of manufacturing a printing material according to claim 12, wherein heating is performed so that the surface portion has a hardness higher than the ink saturating portion.

16. A stamp formed of a thermoplastic porous resin, comprising:
a saturating portion being saturated with ink; and
a surface portion formed by hardening with shrinkage when a surface of the saturating portion saturated with the ink is heated.

17. The stamp according to claim 16, wherein the thermoplastic resin is a polyolefin resin.

18. The stamp according to claim 17, wherein the polyolefin resin forms a printing material by joining a plurality of protruded portions with a plurality of joining portions, each one of the protruded portions having a printing face disposed at approximately each one of a front end portion of the protruded portions, wherein a portion of the printing face is uneven to form at least one of a number, character, and symbol.

19. The stamp according to claim 16, wherein the surface portion has a hardness higher than the ink saturating portion.
